(19) United States
(12) Patent Application Publication
(10) Pub. No.: US 2021/0366052 A1
(43) Pub. Date: Nov. 25, 2021

(54) SYSTEM AND METHOD FOR CATASTROPHIC EVENT MODELING

(71) Applicant: Kovrr Risk Modeling, Ltd., Tel-Aviv (IL)

(72) Inventors: Avi BASHAN, Givat Shmuel (IL); Amir SHUR, Yehuda Karni (IL); Amir KESSLER, Tel Aviv (IL); Shalom BUBLIL, Tel Aviv (IL); Marco LO GIUDICE, London (GB); Yakir GOLAN, Kibbutz Yagur (IL)

(73) Assignee: Kovrr Risk Modeling, Ltd., Tel-Aviv (IL)

(21) Appl. No.: 17/326,499

(22) Filed: May 21, 2021

Related U.S. Application Data
(60) Provisional application No. 63/028,830, filed on May 22, 2020.

(51) Int. Cl. G06Q 40/08; G06N 7/00; G06F 16/24

(52) U.S. Cl. CPC G06Q 40/08; G06F 16/24; G06N 7/005

(57) ABSTRACT

A system and method for generating synthetic hazard data for cyber-insurance are provided. The method includes selecting, from treaty information, a shadow company, wherein the treaty information includes records relating to known companies and at least one shadow company, wherein the treaty information relating to the at least one shadow company does not include hazard data; sampling, from a database, a number of known companies that are part of an insurance treaty; determining a probability distribution for a likelihood that the selected shadow company uses at least one digital asset used by the sampled known companies; generating a set of Apriori rules describing the likelihood that two digital assets are used together; generating, for the selected shadow company, synthetic hazard data; and associating the synthetic hazard data with the selected shadow company.

### CROSS-REFERENCE TO RELATED APPLICATIONS

This application claims the benefit of U.S. Provisional Application No. 63/028,830 filed on May 22, 2020, the contents of which are hereby incorporated by reference.

### TECHNICAL FIELD

The present disclosure relates generally to treaty data analysis and, more specifically, to cyber-insurance treaty data analysis.

### BACKGROUND

As businesses have become more interconnected due to the ubiquitous use of the internet, new challenges arise which can threaten the security of a business. These threats include an increase in cyberattacks and other internet-based attacks. Such attacks can encompass traditional hacking, such as the insertion of viruses within a network, phishing attacks to extract sensitive information, and distributed denial of service attacks, which can disrupt the normal traffic of a network and cause operations to grind to halt. While bad actors still employ these techniques, and while robust security to protect against such attacks is paramount for the safety of a business, recent trends expose businesses to potentially more damaging attacks, including attacks which fall under the category of catastrophic cyber events.

Catastrophic cyber events include cyber-attacks such as ransomware attacks, data leakage, denial of service (DoS) attacks, or other types of malicious activity. Catastrophic cyber events may also include failures caused by a service provider, dysfunctional services, and the like.

As cyber threats continue to become more prevalent, businesses are beginning to consider the possibility of attacks and the related expected costs. Insurance companies now offer cyber-insurance products to protect clients, both from internal loss and from liability arising from loss caused to end users. Further, because of the potentially-increasing magnitude of damage caused by such attacks, insurance and reinsurance companies must also determine the expected likelihood and cost of payouts to their clients, and the matching available capital required. However, because third-party software and services are not fully within the control of the end user, e.g., a business employing such software and hardware, and because new forms of attacks, which are designed to propagate across networks, are regularly developed and deployed, it is difficult to accurately predict when a business will be affected by such exploits and, if affected, how much damage will be caused.

Because these attacks are often novel and without direct precedent, traditional modeling fails to provide accurate numbers, both for the insurance and reinsurance companies, as well as for the businesses themselves. In particular, reinsurance companies should ascertain what their real and anticipated liabilities are, in order to properly price policies. Additionally, many reinsurance companies enter into treaties with other insurance or reinsurance companies in order to pool risk together and spread exposure to liability and large payouts. However, computing accurate liability risk for catastrophic cyber events is challenging.

Consumer data can be valuable for a multitude of reasons, and is, therefore, often kept confidential and not fully shared among reinsurance companies, even those party to a reinsurance treaty. Thus, in entering into insurance treaties, often only high-level and low-resolution data is shared, making accurate predictions and calculations of risk difficult. As cybercrime grows, accurate assessment of aggregated risk becomes increasingly necessary to provide appropriate coverage, despite the limited availability, and the granularity, of relevant data.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating synthetic hazard data for cyber-insurance. The method comprises: selecting, from treaty information, a shadow company, wherein the treaty information includes records relating to known companies and at least one shadow company, wherein the treaty information relating to the at least one shadow company does not include hazard data; sampling, from a database, a number of known companies that are part of an insurance treaty, wherein the sampled known companies include verified hazard data for their digital assets; determining a probability distribution for a likelihood that the selected shadow company uses at least one digital asset used by the sampled known companies; generating a set of apriori rules describing the likelihood that two digital assets are used together; generating, for the selected shadow company, synthetic hazard data, wherein synthetic hazard data is hazard data generated based on the set of apriori rules and the determined the probability distribution; and associating the synthetic hazard data with the selected shadow company.

Certain embodiments disclosed herein also include a non-transitory computer readable medium having stored thereon instructions for causing a processing circuitry to execute a process, the process comprising: selecting, from treaty information, a shadow company, wherein the treaty information includes records relating to known companies and at least one shadow company, wherein the treaty information relating to the at least one shadow company does not include hazard data; sampling, from a database, a number of known companies that are part of an insurance treaty, wherein the sampled known companies include verified hazard data for their digital assets; determining a probability distribution for a likelihood that the selected shadow company uses at least one digital asset used by the sampled known companies; generating a set of apriori rules describing the likelihood that two digital assets are used together; generating, for the selected shadow company, synthetic hazard data, wherein synthetic hazard data is hazard data generated based on the set of apriori rules and the determined the probability distribution; and associating the synthetic hazard data with the selected shadow company.

In addition, certain embodiments disclosed herein include a system for generating synthetic hazard data for cyber-insurance. The system comprises: a processing circuitry; and a memory, the memory containing instructions that, when executed by the processing circuitry, configure the system to: select, from treaty information, a shadow company, wherein the treaty information includes records relating to known companies and at least one shadow company, wherein the treaty information relating to the at least one shadow company does not include hazard data; sample, from a database, a number of known companies that are part of an insurance treaty, wherein the sampled known companies include verified hazard data for their digital assets; determine a probability distribution for a likelihood that the selected shadow company uses at least one digital asset used by the sampled known companies; generate a set of apriori rules describing the likelihood that two digital assets are used together; generate, for the selected shadow company, synthetic hazard data, wherein synthetic hazard data is hazard data generated based on the set of apriori rules and the determined the probability distribution; and associate the synthetic hazard data with the selected shadow company.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram illustrating a deployment of a cyber-insurance system for cyber-insurance treaty data analysis, according to an embodiment.

FIG. 2 is a flowchart describing a method for cyber-insurance treaty analysis, according to an embodiment.

FIG. 3 is a block diagram of the cyber-insurance system, implemented according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for cyber-insurance treaty data analysis. The method includes sampling hazard data for known companies, generating statistical distributions of such hazard data, and applying such hazard data distributions to synthesize hazard data for unknown or “shadow” companies. The generation of statistical distributions includes evaluating hazard data for known companies, where the sampled known companies match the unknown or “shadow” company in one or more respects, such as, as examples and without limitation, company location, company industry, and the like.

The embodiments disclosed herein provide certain improvements in the processing and application of data in analysis of cyber-insurance treaty data. As described herein, the methods, structures, and the like, included in, and applied by, the various aspects of the disclosed embodiments provide for improvements in analysis accuracy and granularity. Specifically, as further described herein, the features of the disclosed embodiments provide for enhanced accuracy of analysis, where such analysis is applicable to providing synthesized hazard data. Further, the features of the disclosed herein provide for the enhanced granularity of analysis processes, providing for improvements to the results of such processes, where such results are applied as described herein.

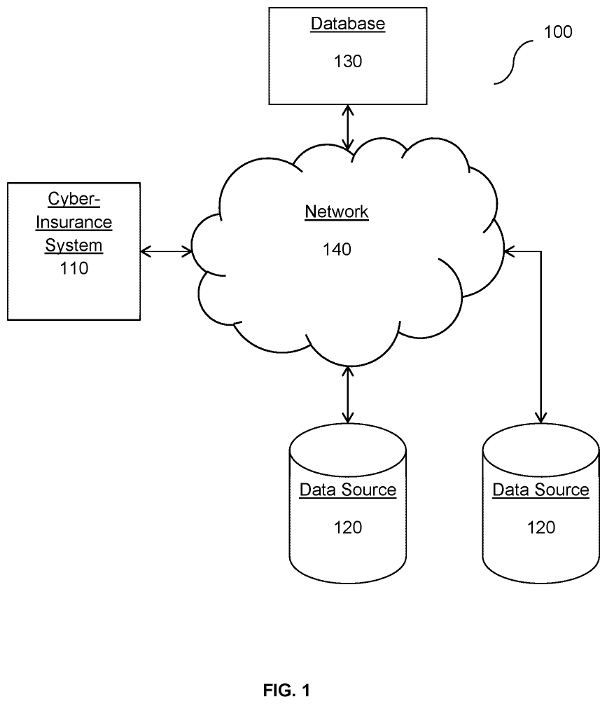

FIG. 1 shows an example network diagram 100 illustrating a deployment of a cyber-insurance system 110 for cyber-insurance treaty data analysis, according to an embodiment.

The diagram 100 depicts the cyber-insurance system 110, a plurality of data sources 120, and a database 130, communicating over a network 140. The network 140 may be, but is not limited to, a wireless, cellular, or wired network, a local area network (LAN), a wide area network (WAN), a metro area network (MAN), the Internet, the world wide web (WWW), a network similar to those described, and any combination thereof.

In an example embodiment, the data sources 120 provide the data used for past events extrapolation. The data sources 120 may include Common Vulnerabilities and Exposures (CVE) databases, open-source monitoring dashboards, active exploitation databases, and threat intelligence data sources.

The cyber-insurance system 110 is configured to perform various functions, including those described according to the embodiments disclosed herein. Specifically, the cyber-insurance system 110 is configured to implement processes for cyber-insurance treaty analysis. In the context of insurance, including within applications to cyber-insurance and re-insurance, “treaty reinsurance” describes an agreement between an insurer and a reinsurer, whereby the reinsurer agrees to insure a group of insurance policies in exchange for some compensation from the insurer. Further, as is applicable to the context of cyber-insurance, the individual insurance policies may be agreements between companies and the insurer, the individual insurance policies providing for coverage, by the insurer, of risks of loss caused by cyber-events, in exchange for some compensation, where the compensation is paid from the insured company to the insurer. In addition, treaty information is information relating to the companies, policies, and other, like, aspects of a treaty agreement, as described. Treaty information may include, as examples and without limitation, insurance policy information, information describing the insured company, hazard information, and the like, as well as any combination thereof.

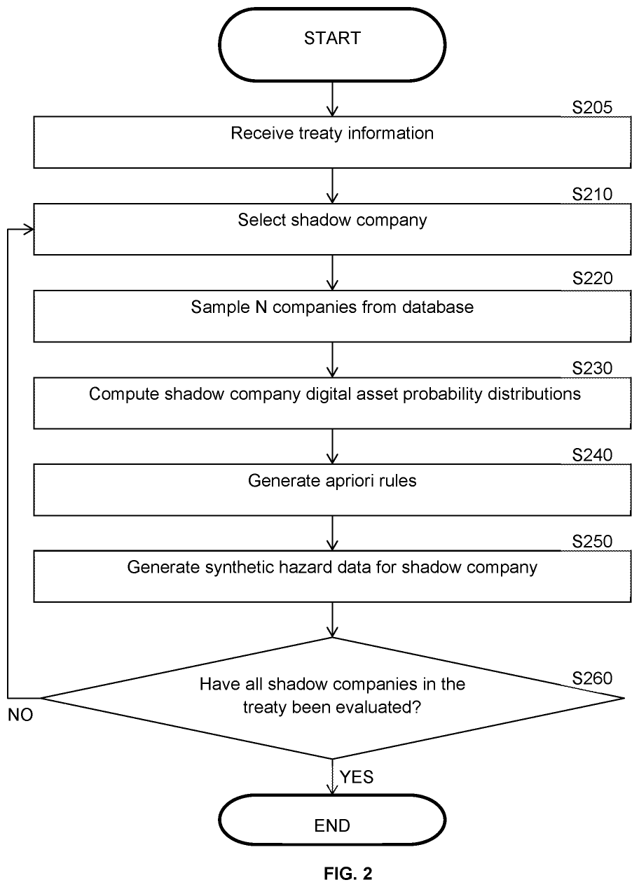

As is discussed with reference to FIG. 2, the cyber-insurance treaty analysis, as performed by the cyber-insurance system 110, may include the generation of synthetic hazard data, applicable to augmentation of shadow companies, to create full-portfolio data representing cyber risks of a similar, full-information portfolio, based on observed correlations between hazard data, company business fields, and the countries of companies' operation or incorporation. Analysis may include consideration of one or more treaties. The treaties considered may include “known” and “shadow” companies. In some cases, treaties may include only “unknown” companies. A known company means that the company information (such as name, industry, and location(s)) and hazard data is available and verified. A shadow company is a company for which only general firmographic information is known, i.e., information such as company location and industry, but not the shadow company's explicit identity.

In an embodiment, the cyber-insurance system 110 is configured to analyze the company hazards based on limited information. For a company about which limited information is known, information relevant to treaty analysis, as described below, may include the company's location and industry. As an example, relevant treaty analysis data for a given shadow company may include data specifying that the company is from France (FR), data specifying that the company's industry is wholesale trade (Standard Industrial Classification code 50), and data concerning the company's insurance terms and conditions. Based on this information, cyber-insurance treaty analysis may be performed as described below to provide or associate synthetic hazard data.

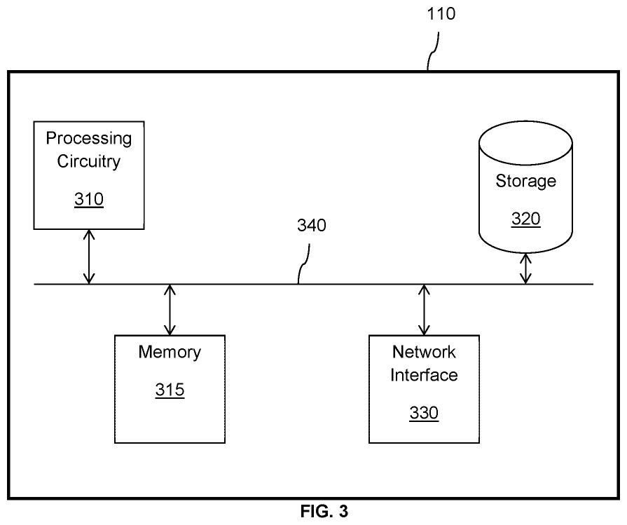

The cyber-insurance system 110 may be implemented as a physical machine, a virtual machine, or a combination thereof. A block diagram of an example depicting a physical machine implementation is discussed below with reference to FIG. 3. A virtual machine may be any virtual software entity, such as a software container, a microservice, a hypervisor, and the like.

The database 130 may store, hazard tables, other reports generated according to the disclosed embodiments, other, like, data, and any combination thereof. The database 130 may be a relational database or a NoSQL type of database such as, as an example and without limitation, MongoDB. Examples of relational databases include, without limitation, Oracle®, Sybase®, Microsoft SQL Server®, Access®, Ingres®, and the like. In an embodiment, the database 130 may be a plurality of logical entities residing in the same physical structure.

In an embodiment, the database 130 may be included in the cyber-insurance system 110. In an alternate embodiment, the database 130 may be realized as separate components connected directly with the network 140, with the cyber-insurance system 110, or both.

It should be noted that the embodiments disclosed herein are not limited to the specific architecture illustrated in FIG. 1, and that other architectures may be equally used without departing from the scope of the disclosed embodiments. Specifically, the cyber-insurance system 110 may reside in a cloud computing platform, a datacenter, or the like. The cloud computing platform may be a private cloud, a public cloud, a hybrid cloud, and the like. Moreover, in an embodiment, there may be a plurality of systems operating as a distributed system. Further, the database 130 may be distributed as well. In some implementations, the cyber-insurance system 110 may be an internal component or instance of any of the data sources 120. In an embodiment, the cyber-insurance system 110 may include one or more data stores, configured to save collected or analyzed data.

FIG. 2 is an example flowchart 200 describing a method for cyber-insurance treaty analysis, according to an embodiment. The method may be performed by a cyber-insurance system 110.

At S205, information regarding a treaty is received. The treaty information includes a number of shadow companies with missing accurate identification details, such as names, but includes partial firmographic details for the same companies, such as geographic location, industry, and the like. To analyze the risk of the treaty, the treaty information is augmented by the creation of a synthetic portfolio, as described below. The treaty information may be received by querying a database of an insurance or reinsurance company. Alternatively, or in combination with other, disclosed embodiments, the information may be pushed through, for example, an API. The treaty information may be structured data or un-structured data. The structured data may be in formats such as, for example and without limitation, comma-separated value (CSV), extensible markup language (XML), JavaScript object notation (JSON), and the like. The un-structured data may be in formats such as, as examples and without limitation, PDF files, image files, text files, and the like, or combination thereof.

At S210, a shadow company is selected from the received treaty information. A shadow company is a company for which only general firmographic information is known. The selection of the shadow company may include scanning the received treaty information and selecting every company listed therein which meets the criteria of a shadow company. The process described herein may be performed for each selected shadow company, if more than one such company exits. Further, the geographic location and industry of the selected shadow company are obtained.

At S220, a number of known companies is sampled from a database. The sampled known companies are not shadow companies. The number of sampled known companies is an integer number that may be pre-configured or determined based on the set (total number) of companies in the database. For example, the number of sampled known companies is determined in such a way as to provide efficient processing and to avoid overloading any computing resources of the computer. The database may be a database such as the database, 130, of FIG. 1, above, another, like, database, or a combination thereof. Further, the database may be an external database, accessible by web, internet, or other networked communication means. In an embodiment, the database may be an industry exposure database.

The identifying details of the sampled known companies from the database are used to actively scan for up-to-date hazard data that may be relevant to the sampled, known companies. Generally, hazard data is verified information and includes technologies, applications, and services (collectively referred to as “digital assets”) utilized or deployed by each company in the database. Hazard data may include, for example, data indicating that the company is using Office 365®, Zoom® communication, and AWS® to run the company's business applications. Further, hazard data may indicate one or more risks which a company faces due to implemented services or technologies, or similar potential risks.

In an embodiment, the sampled known companies may include companies matching the country and industry of the selected shadow company. As an example, sampling at S220 may include sampling ten companies matching FR-50, where FR describes the shadow company's country, France, and where 50 describes the shadow company's Standard Industrial Classification, 50.

Sampling, as at S220, may include the estimation of full population size and determination of the number of companies to be sampled. Where sampling at S220 includes estimation of the full population size and the determination of the number of companies to be sampled, the number of companies to be sampled may be determined as described hereinabove, while the full population size may be estimated based on, for example and without limitation, the number of entries in the database. Sampling at S220 may be based on data including, without limitation, global organization data, which may be controlled by an analytic organization and regularly updated, and treaty company data based on geolocation. For example, the analysis of company data in the treaty information may be based on geolocation, to include searching for farming companies and adding the identified farming companies' information to the sampled data. In this example, a farming company may be sampled from an industry exposure database, including the database, 130, of FIG. 1, above. It should be appreciated that the example provided is simplified for purposes of illustration, and that real analyses may involve greater complexity and larger volumes of data.

The output of S220 may be the hazard data of digital assets used by the sampled known companies matching the selected shadow company's geographic location (country) and industry.

At S230, probability distributions, indicating the likelihood that the selected shadow company uses digital assets which are the same as, or similar to, those used by the sampled known company, are computed. As noted above, the assets of the sampled known companies are available as verified hazard data. In an example embodiment, the computation is made using a Bayesian inference model with Monte Carlo Markov-Chain simulations. The Bayesian inference model is executed over the hazard data provided at S220, correlated with industry-based hazard data. The industry-based hazard data includes digital assets commonly used in the industry and location of the shadow company. The industry-based hazard data is collected over time, and may be saved in a database, such as the database, 130, of FIG. 1, above. Further, the industry-based hazard data may include pre-computed distributions based on market analysis of the popularities of service providers and technologies. The operation of Bayesian inference models may be readily understood by one of ordinary skill in the art.

The outputs of S230 are probability distributions reflecting the likelihood that the shadow company uses each digital asset determined at S220.

At S240, apriori rules are generated. Apriori rules describe the likelihoods of one or more given technologies and services being used together. The rules are determined using an apriori algorithm and industry hazard data. Generally, the apriori algorithm is directed to the determination of correlations between variables based on information correlation with statistical information. The rules generated by the apriori algorithm, which may be known as “apriori rules,” may be directed to the indication of general trends within a set of evaluated records, such as companies included in the set of known companies, as sampled at S220, based on associations between data elements.

According to the disclosed embodiments, the Apriori rules generated at S240 may include weighting values computed by the Apriori algorithm to emphasize or de-emphasize particular correlations in the hazard data. As an example, an Apriori rule may indicate that most companies using a given cloud computing platform (e.g., Microsoft Azure®) also use productivity software (e.g., Microsoft Office 365®) developed by the same vendor.

At S250, based on the probability distributions computed at S230 and the Apriori rules generated at S240, synthetic hazard data for the selected shadow company is generated. Synthetic hazard data may be data reflecting hazards similar to those hazards identified based on collected data. Synthetic hazard data may be generated using the rules generated at S240, in combination with distributions computed at S230, to identify potential hazards for which no data exists. Generation of synthetic hazard data at S250 may include, without limitation, selection of one or more shadow company categories, followed by population, from the Apriori rules, of various hazard data. Synthetic hazards may be applicable to the analysis of cyber-insurance treaty information, and may be subsequently analyzed separately from, or in combination with, non-synthetic hazards. The synthetic hazard data may be saved in a database with an association to the selected shadow company.

At S260, it is checked whether all shadow companies in the treaty have been evaluated. If so, execution ends; otherwise, execution returns to S210, where another shadow company is selected.

FIG. 3 is an example block diagram of the cyber-insurance system 110, implemented according to an embodiment. The cyber-insurance system 110 includes a processing circuitry 310 coupled to a memory 315, a storage 320, and a network interface 330. In an embodiment, the components of the cyber-insurance system 110 may be communicatively connected via a bus 340, e.g., PCIe or other high-speed data bus.

The processing circuitry 310 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, graphics processing units (GPUs), tensor processing units (TPUs), general-purpose microprocessors, microcontrollers, and digital signal processors (DSPs), and the like, or any other hardware logic components that can perform calculations or other manipulations of information.

The memory 315 may be volatile (e.g., RAM, etc.), non-volatile (e.g., ROM, flash memory, etc.), or a combination thereof. In one configuration, computer-readable instructions to implement one or more embodiments disclosed herein may be stored in the storage 320.

In another embodiment, the memory 315 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 310 to perform the various processes described herein.

The storage 320 may be magnetic storage, optical storage, and the like, and may be realized, for example, as flash memory or other memory technology, CD-ROM, Digital Versatile Disks (DVDs), or any other medium which can be used to store the desired information.

The network interface 330 allows the cyber-insurance system 110 to communicate with the at least one of the various data sources or databases.

It should be understood that the embodiments described herein are not limited to the specific architecture illustrated in FIG. 3, and that other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating synthetic hazard data for cyber-insurance, comprising:
selecting, from treaty information, a shadow company, wherein the treaty information includes records relating to known companies and at least one shadow company, wherein the treaty information relating to the at least one shadow company does not include hazard data;
sampling, from a database, a number of known companies that are part of an insurance treaty, wherein the sampled known companies include verified hazard data for their digital assets;
determining a probability distribution for a likelihood that the selected shadow company uses at least one digital asset used by the sampled known companies;
generating a set of Apriori rules describing the likelihood that two digital assets are used together;
generating, for the selected shadow company, synthetic hazard data, wherein synthetic hazard data is hazard data generated based on the set of Apriori rules and the determined the probability distribution; and
associating the synthetic hazard data with the selected shadow company.

2. The method of claim 1, wherein the method is repeated for each shadow company included in the treaty information.

3. The method of claim 1, wherein the number of known companies is a function of a count of the known companies included in the database.

4. The method of claim 1, wherein treaty information includes information on companies organized in an insurance treaty, wherein at least one of the companies in the treaty information is a shadow company having identifying details but missing hazard data.

5. The method of claim 1, further comprising:
determining the probability distribution using a Bayesian inference model with Monte Carlo Markov-Chain simulation.

6. The method of claim 1, wherein determining the probability distribution further comprises:
correlating hazard data of the sampled known companies with industry-based hazard data, wherein industry-based hazard data includes digital assets commonly used in the industry and location of the shadow company.

7. The method of claim 1, wherein the database is an industry exposure database.

8. The method of claim 1, wherein a digital asset is at least one of: a technology, an application, or a service, which is utilized or deployed by a company included in the database.

9. The method of claim 1, wherein generating at least an Apriori rule further comprises:
applying at least an Apriori algorithm to a set of data, wherein the set of data includes hazard data of the companies included in the sampled known companies and industry hazard data.

10. A non-transitory computer readable medium having stored thereon instructions for causing a processing circuitry to execute a process, the process comprising:
selecting, from treaty information, a shadow company, wherein the treaty information includes records relating to known companies and at least one shadow company, wherein the treaty information relating to the at least one shadow company does not include hazard data;
sampling, from a database, a number of known companies that are part of an insurance treaty, wherein the sampled known companies include verified hazard data for their digital assets;
determining a probability distribution for a likelihood that the selected shadow company uses at least one digital asset used by the sampled known companies;
generating a set of Apriori rules describing the likelihood that two digital assets are used together;
generating, for the selected shadow company, synthetic hazard data, wherein synthetic hazard data is hazard data generated based on the set of Apriori rules and the determined the probability distribution; and
associating the synthetic hazard data with the selected shadow company.

11. A system for generating synthetic hazard data for cyber-insurance, comprising:
a processing circuitry; and
a memory, the memory containing instructions that, when executed by the processing circuitry, configure the system to:
select, from treaty information, a shadow company, wherein the treaty information includes records relating to known companies and at least one shadow company, wherein the treaty information relating to the at least one shadow company does not include hazard data;
sample, from a database, a number of known companies that are part of an insurance treaty, wherein the sampled known companies include verified hazard data for their digital assets;
determine a probability distribution for a likelihood that the selected shadow company uses at least one digital asset used by the sampled known companies;
generate a set of Apriori rules describing the likelihood that two digital assets are used together;
generate, for the selected shadow company, synthetic hazard data, wherein synthetic hazard data is hazard data generated based on the set of apriori rules and the determined the probability distribution; and
associate the synthetic hazard data with the selected shadow company.

12. The system of claim 11, wherein the system is configured to repeat the instructions for each shadow company included in the treaty information.

13. The system of claim 11, wherein the number of known companies is a function of a count of the known companies included in the database.

14. The system of claim 11, wherein treaty information includes information on companies organized in an insurance treaty, wherein at least one of the companies in the treaty information is a shadow company having identifying details but missing hazard data.

15. The system of claim 11, wherein the system is further configured to:
determine the probability distribution using a Bayesian inference model with Monte Carlo Markov-Chain simulation.

16. The system of claim 11, wherein the system is further configured to:
correlate hazard data of the sampled known companies with industry-based hazard data, wherein industry-based hazard data includes digital assets commonly used in the industry and location of the shadow company.

17. The system of claim 11, wherein the database is an industry exposure database.

18. The system of claim 11, wherein a digital asset is at least one of: a technology, an application, or a service, which is utilized or deployed by a company included in the database.

19. The system of claim 11, wherein the system is further configured to:
apply at least an Apriori algorithm to a set of data, wherein the set of data includes hazard data of the companies included in the sampled known companies and industry hazard data.
